(19) United States
(12) Patent Application Publication
(10) Pub. No.: US 2024/0334542 A1
(43) Pub. Date: Oct. 3, 2024

(54) SYSTEM AND METHOD FOR PRIORITIZATION OF DEVICE CONNECTIONS

(71) Applicant: LENOVO (SINGAPORE) PTE. LTD., SINGAPORE (SG)

(72) Inventors: Mark Christopher Heidenfeldt, Apex, NC (US); Richard Todd Wall, Garner, NC (US); Mark K. Summerville, Apex, NC (US); Sandy Collins, Durham, NC (US); Justin Ringuette, Cary, NC (US)

(21) Appl. No.: 18/193,778

(22) Filed: Mar. 31, 2023

(51) Int. Cl. H04W 76/36; H04W 76/10

(52) U.S. Cl. CPC H04W 76/36; H04W 76/10

(57) ABSTRACT

A device connection system and method include receiving, via one or more processors of a first electronic device, a signal to initiate a wireless connection process, and accessing a user-defined priority list to determine a group of pairing electronic devices and a prioritized order of the pairing electronic devices in the group. The system and method include transmitting a connection request to one or more of the pairing electronic devices in the group, one at a time according to the prioritized order in the user-defined priority list, and establishing a wireless communication link between the first electronic device and a second electronic device. The second electronic device is one of the pairing electronic devices in the group that is first to respond to the connection request.

### FIELD

The present disclosure generally relates to controlling communication links between different pairs of devices.

### BACKGROUND OF THE INVENTION

Some devices are designed to wirelessly communicate with each other over relatively short ranges, such as within 15 meters (50 feet). Bluetooth is a prevalent short-range wireless technology standard that uses radio communication technology and is designed for relatively low power consumption. Bluetooth is a packet-based protocol with a leader/follower architecture. A single device may pair with multiple other devices in order to form different combinations of paired connections. For example, a vehicle radio and/or infotainment device may connect to multiple different smartphones of different vehicle passengers. In another example, a single pair of earbud headphones can independently connect to a laptop computer, a smartphone, and a smart watch via different communication links. Yet, each device may communicate via Bluetooth with only one other device at a time. The possibility of connecting with multiple different devices combined with the limitation of only one communication link at a time can make setting up connections between desired devices difficult and convoluted. A common occurrence is that a first device makes an undesired connection with a second device instead of making a desired connection with a third device. The remedial process typically involves manual intervention in the form of accessing Bluetooth settings via a user interface in a device, deactivating Bluetooth on the undesired second device to disconnect the second device, initiating or reinitiating Bluetooth on the desired third device, and/or the like. These processes are inefficient and can be confusing.

A need remains for prioritizing devices for paired, short-range wireless connections to provide efficient, desired connections.

### SUMMARY

In accordance with an embodiment, a method for establishing a device connection for wireless communications is provided. The method includes receiving, via one or more processors of a first electronic device, a signal to initiate a wireless connection process. The method includes accessing a user-defined priority list to determine a group of pairing electronic devices and a prioritized order of the pairing electronic devices in the group. The method includes transmitting a connection request to one or more of the pairing electronic devices in the group, one at a time according to the prioritized order in the user-defined priority list, and establishing a wireless communication link between the first electronic device and a second electronic device. The second electronic device is one of the pairing electronic devices in the group that is first to respond to the connection request.

Optionally, the method includes (i) transmitting, by the first electronic device, outgoing data packets to the second electronic device via the wireless communication link, and/or (ii) receiving, at the first electronic device, incoming data packets from the second electronic device via the wireless communication link. Optionally, establishing the wireless communication link may involve establishing a bi-directional communication link between the first electronic device and the second electronic device according to the Bluetooth protocol.

In response to receiving a second connection request from a third electronic device after establishing the wireless communication link, the method may include comparing the third electronic device to the second electronic device according to the prioritized order in the user-defined priority list. The method may include rejecting the second connection request in response to determining that the second electronic device has a higher priority than the third electronic device. Alternatively, in response to determining that the third electronic device has a higher priority than the second electronic device, the method may include dropping the wireless communication link between the first electronic device and the second electronic device and establishing a second wireless communication link between the first electronic device and the third electronic device.

Optionally, the user-defined priority list is a first user-defined priority list in a set of multiple different user-defined priority lists associated with different situations. The method may include selecting the first user-defined priority list from the set. The first user-defined priority list may be selected based on a situation. Optionally, the method may include receiving a sensor measurement generated by a sensor device, and the first user-defined priority list is selected from the set in response to determining that the first user-defined priority list is more applicable than another user-defined priority list in the set based on the sensor measurement. The sensor measurement may be indicative of a location of the first electronic device and/or an activity of a user that controls the first electronic device. Optionally, the method may include determining a time of day, and the first user-defined priority list is selected from the set in response to determining that the first user-defined priority list is more applicable than another user-defined priority list in the set based on the time of day.

In accordance with an embodiment, a device connection system is provided that includes a memory configured to store program instructions, a wireless communication device onboard a first electronic device, and one or more processors communicatively connected to the memory and the wireless communication device. The program instructions are executable by the one or more processors to receive a signal to initiate a wireless connection process, and access a user-defined priority list stored in the memory to determine a group of pairing electronic devices and a prioritized order of the pairing electronic devices in the group. The program instructions are executable by the one or more processors to transmit, via the wireless communication device, a connection request to one or more of the pairing electronic devices in the group, one at a time according to the prioritized order in the user-defined priority list, and establish a wireless communication link between the first electronic device and a second electronic device. The second electronic device is one of the pairing electronic devices in the group that is first to respond to the connection request.

Optionally, the program instructions are executable by the one or more processors to control the wireless communication device to (i) transmit outgoing data packets to the second electronic device via the wireless communication link and/or (ii) receive incoming data packets from the second electronic device via the wireless communication link. Optionally, responsive to receiving a second connection request from a third electronic device after establishing the wireless communication link, the program instructions are executable by the one or more processors to compare the third electronic device to the second electronic device according to the prioritized order in the user-defined priority list. The program instructions may be executable by the one or more processors to reject the second connection request in response to the one or more processors determining that the second electronic device has a higher priority than the third electronic device in the user-defined priority list. Alternatively, in response to the one or more processors determining that the third electronic device has a higher priority than the second electronic device in the user-defined priority list, the program instructions may be executable by the one or more processors to drop the wireless communication link between the first electronic device and the second electronic device, and establish a second wireless communication link between the first electronic device and the third electronic device.

Optionally, the user-defined priority list is a first user-defined priority list in a set of multiple different user-defined priority lists associated with different situations. The program instructions may be executable by the one or more processors to select the first user-defined priority list from the set (to enforce instead of other user-defined priority lists in the set). The program instructions may be executable by the one or more processors to analyze a sensor measurement generated by a sensor device, and select the first user-defined priority list from the set by determining that the first user-defined priority list is more applicable than another user-defined priority list in the set based on the sensor measurement. The sensor measurement may be indicative of a location of the first electronic device and/or an activity of a user that controls the first electronic device. Optionally, the program instructions are executable by the one or more processors to determine a time of day, and select the first user-defined priority list from the set by determining that the first user-defined priority list is more applicable than another user-defined priority list in the set based on the time of day.

In accordance with an embodiment, a computer program product is provided that includes a non-transitory computer readable storage medium. The non-transitory computer readable storage medium includes computer executable code configured to be executed by one or more processors to receive a signal to initiate a wireless connection process, and select a first user-defined priority list in a set of multiple different user-defined priority lists stored in the non-transitory computer readable storage medium and associated with different situations. The computer executable code is configured to be executed by one or more processors to access the first user-defined priority list to determine a group of pairing electronic devices and a prioritized order of the pairing electronic devices in the group, and to transmit, via a wireless communication device of a first electronic device, a connection request to one or more of the pairing electronic devices in the group one at a time according to the prioritized order in the first user-defined priority list. The computer executable code is configured to be executed by one or more processors to establish a Bluetooth communication link between the first electronic device and a second electronic device. The second electronic device is one of the pairing electronic devices in the group that is first to respond to the connection request.

### BRIEF DESCRIPTION OF THE DRAWINGS

FIG. 1 is a block diagram of an device connection system according to an example of the present disclosure.

FIG. 2 is a diagram of a network of devices according to an embodiment.

FIG. 3 is a flow chart of a method of wirelessly connecting devices according to an embodiment.

FIG. 4 illustrates a first user-defined priority list according to an example embodiment.

FIG. 5 illustrates a second user-defined priority list according to an example embodiment.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

Examples of the present disclosure provide a device connection system and method for prioritizing wireless connections between different pairs of devices. Embodiments described herein permit a user to rank devices within a user-defined priority list, which controls the order at which a first device attempts to establish wireless communication links with other devices. The device connection system and method may attempt to establish wireless communication links based on a prioritized order in the user-defined priority list. If a third device requests a connection to a first device that is currently connected to a second device, the device connection system and method may compare the ranking of the third device to the second device in the user-defined priority list. If the third device ranks lower than the second device, the system and method may deny the request by the third device. On the other hand, if the third device outranks the second device, the system and method may automatically drop the wireless connection with the second device and establish a new wireless connection between the first device and the third device. As such, the system and method may treat the prioritized order as having precedence over even pre-existing connections between devices. The user-defined priority list may be updated by a user based on user preferences. Optionally, the device connection system and method may select which user-defined priority list to apply from among multiple different user-defined priority lists. The selection process may be based on context. For example, one list may be more applicable (e.g., appropriate) for a first situation, and another list may be more applicable for a second situation. The situation may refer to time of day, location of an electronic device on which the system and method operate, activity of a user that controls the electronic device, a type of use or operation of the electronic device, historical user selections (e.g., heuristics) of the user that controls the electronic device, and/or the like.

The device connection system and method may reduce delays, confusion, distraction, and frustration associated with undesired connections between paired devices. For example, the Bluetooth (registered trademark owned by Bluetooth SIG, Inc.) protocol does not currently have a standard or default setting for setting priority on devices. As a result, the operating systems on individual electronic devices may independently self-manage Bluetooth connections with other electronic devices. Some electronic devices may generate a default priority list based on an order at which the respective device pairs with other devices over time. A smartphone, for example, may give the highest rank to the first device ever paired with the smartphone. Another smartphone may give the highest rank to the last device paired with the smartphone. Other electronic devices may set the respective priority list of paired devices based on the most recent connection (e.g., established communication link). For example, a set of earbud headphones may automatically attempt to connect to the electronic device that was most recently connected to the earbuds before attempting to connect to other electronic devices that were previously connected to the earbuds. This framework of independent self-managing of wireless connections causes uncertainty and failed attempts to establish wireless communication links between desired devices. The device connection system and method described herein may resolve many of these issues by enabling a user to select the prioritized order of device connections according to preference, instead of using default, static, and/or unspecified connection priorities. For example, the device connection system may be a management tool for wireless connection device prioritization that allows the user to configure which devices are searched for first, and which connections should override existing connections between devices. The system and method may also resolve these issues by modifying the prioritized order based on context, such that the order in effect at a given time is applicable (e.g., appropriate) to the user's current situation. This context-based approach to device prioritization provides different devices and/or device rankings as the user transitions from work or school to home, the car, the gym, and/or the like.

References herein to “electronic devices”, unless specified, shall mean any of various types of hardware devices that can connect to another electronic device by establishing a wireless communication link with the other electronic device. For example, the electronic devices described herein may be able to establish direct, wireless radio communication links with other electronic devices to communicate data between the two electronic devices that are connected during a given time period. Example electronic devices can include personal computing devices (e.g., laptop computers, desktop computers, tablet computers, etc.), smartphones, smart watches and other wearable computing devices, headphones, headsets, computer mice, computer keyboards, audio speakers, digital assistant devices, televisions, and the like. The wireless communication link may be bi-directional to enable a first electronic device to transmit outgoing data to a second electronic device and receive incoming data from the second electronic device. In an embodiment, the electronic devices described herein are Bluetooth-enabled devices that have the hardware and software necessary to pair and communication with other electronic devices according to the Bluetooth protocol. For example, the electronic devices may perform the short-range radio technology known as frequency-hopping spread spectrum to transmit packets of data directly between two connected electronic devices. Although embodiments described herein refer to Bluetooth, the wireless connections described herein may not be limited to Bluetooth connections. Optionally, the electronic devices may be able to establish wireless radio communication links with each other that are not Bluetooth links (e.g., the Bluetooth protocol is not used to make the device connections).

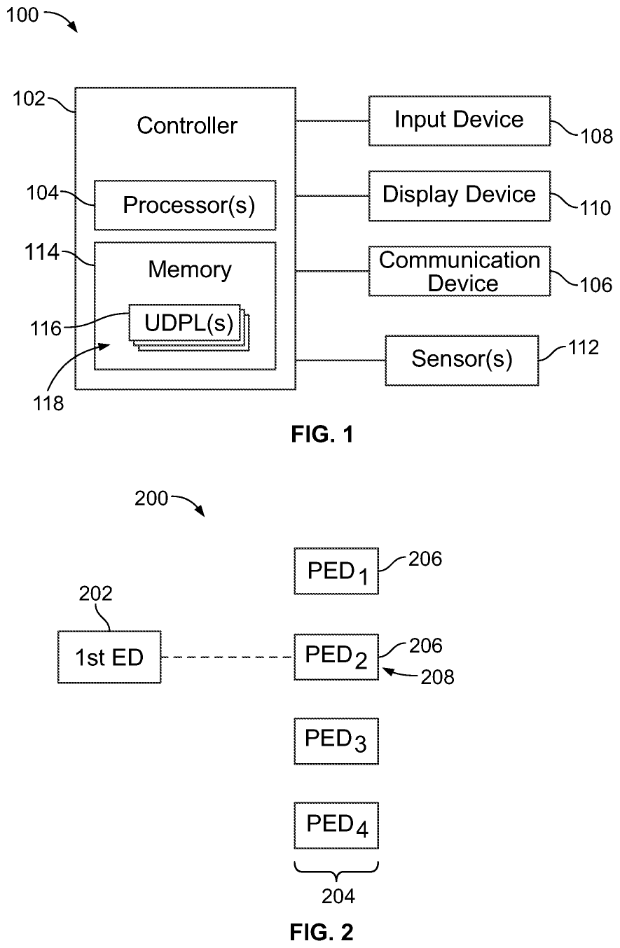

FIG. 1 is a block diagram of an device connection system 100 according to an embodiment. The device connection system 100 includes a controller 102 that performs some or all of the operations described herein to establish wireless communication links between pairs of devices according to prioritized device orders. The device connection system 100 may include an input device 108 and a display device 110 for allowing interaction with one or more users (e.g., people). The device connection system 100 may also include a wireless communication device 106 for sending and receiving data along a wireless communication link. In an embodiment, the device connection system 100 includes one or more sensors 112. The controller 102 may select which priority list of multiple priority lists to enforce at a given time based on context provided by sensor measurements of the sensor(s) 112. The controller 102 is operably connected to the other components of the device connection system 100 via wired and/or wireless communication links to permit the transmission of information in the form of signals. For example, the controller 102 may generate control signals that are transmitted to the other components to control operation of the components. The device connection system 100 may have additional components that are not shown in FIG. 1. In an alternative embodiment, the device connection system 100 may lack one or more of the components shown in FIG. 1, such as the sensor(s) 112.

The controller 102 represents hardware circuitry that includes and/or is connected with one or more processors 104 (e.g., one or more microprocessors, integrated circuits, microcontrollers, field programmable gate arrays, etc.). The controller 102 includes and/or is connected with a tangible and non-transitory computer-readable storage medium (e.g., data storage device), referred to herein as memory 114. The memory 114 may store programmed instructions (e.g., software) that are executed by the one or more processors 104 to perform the device connection operations described herein. The programmed instructions may include one or more algorithms utilized by the one or more processors 104. References herein to the controller 102 may refer to the one or more processors 104 thereof. The controller 102 may include a clock device that tracks the time of day. The one or more processors 104 may refer to the clock device to determine the time of day for time-stamps and/or providing situational awareness for the operations of the device connection system 100 described herein.

The wireless communication device 106 represents hardware circuitry that can communicate electrical signals via wireless communication pathways. The wireless communication device 106 may include transceiving circuitry (e.g., a transceiver or a receiver and discrete transmitter), one or more antennas, and the like for radio communication. In an example, the wireless communication device 106 includes necessary components to send and receive Bluetooth communications with a connected electronic device. The input device 108 is designed to receive user-based inputs from a user that interacts with the input device 108 to generate user selections. The user selections are control signals that are communicated from the input device 108 to the controller 102. The input device 108 may include or represent a touch sensitive screen or touch pad, a mouse, a keyboard, a joystick, a switch, physical buttons, a microphone that receives audio inputs, and/or the like. A user may actuate (e.g., manipulate, provide touch inputs, provide voice inputs, etc.) the input device 108 to generate a user selection. The display device 110 includes a display screen that presents graphical indicia, such as images, shapes, text and symbols, for viewing by the user. The display device 110 may display a graphical user interface (GUI) that presents information to the user. The GUI optionally may prompt the user to make user selection.

The device connection system 100 may be incorporated in an individual electronic device. For example, the device connection system 100 may be incorporated into a personal computer (e.g., laptop, desktop, tablet, etc.), a smartphone, a smart watch, headphones, an audio speaker, and/or the like. The controller 102, input device 108, display device 110, wireless communication device 106, and sensor(s) 112 may be components of the host electronic device. The device connection algorithm according to the embodiments described herein may be implemented in the firmware or software layers of the host electronic device onto which the device connection system 100 is integrated. For example, the device connection algorithm may be integrated directly into an operating system of the host electronic device, within a standalone firmware application that is downloaded separately on the host electronic device (e.g., such as in the form of a plug-in extension or the like), within an application (e.g., app) that is downloaded onto the host electronic device, or the like. In an embodiment in which the wireless communication link is a Bluetooth communication link, the device connection algorithm may be within the Bluetooth driver, below the Bluetooth driver closer to the hardware, or above the Bluetooth driver in the operating space (e.g., in the operating system itself or service on top of the operating system).

The memory 114 may store at least one user-defined priority list 116. Each user-defined priority list 116 contains a prioritized order of one or more electronic devices in a group. The electronic devices in the group may be paired to the host electronic device that contains the device connection system 100. As such, the electronic devices in the priority list(s) 116 are referred to herein as pairing electronic devices. The prioritized order of the pairing electronic devices may be set by a user using the input device 108 or another input device. For example, the user may access settings of a connection management tool to view a list of pairing electronic devices on the display device 110. The user may utilize the input device 108 to assign a rank to the pairing electronic devices from highest priority to lowest priority. The user may update the prioritized order of the pairing electronic devices, when desired, by accessing the settings via the input device 108.

In an embodiment in which the electronic device that hosts the device connection system 100 lacks one or more of the components shown in FIG. 1, the host electronic device may communicate with one or more other electronic devices in a mesh network to receive needed information/data. For example, the device connection system 100 may be implemented by a set of headphones that lacks the input and display devices necessary to allow a user to design or modify a user-defined priority list 116. In that case, the controller 102 may use the wireless communication device 106 of the headphones to query other devices to determine whether the memory 114 of the headphones includes the most recent version of the one or more user-defined priority lists 116. If the headphones are not up-to-date, the headphones may receive the most recent updates from one or more other electronic devices in the mesh network.

In an example, the memory 114 includes a set 118 of multiple different user-defined priority lists 116 that are applicable to different situations. For example, a first user-defined priority list 116 may be applicable to business hours (e.g., 8 AM to 5 PM Monday through Friday) in which the user may be at work and/or school, and a second user-defined priority list 116 may be applicable to non-business hours. In another example, a first user-defined priority list 116 may be applicable to the user being at work, a second user-defined priority list 116 may be applicable to the user being in a home, and a third user-defined priority list 116 may be applicable to the user being at a gym, and a fourth user-defined priority list 116 may be applicable to the user being in a vehicle. In still another example, a first user-defined priority list 116 may be applicable to the user being relatively inactive, and a second user-defined priority list 116 may be applicable to the user being relatively active. Additional examples are described herein in more detail. Storing multiple different user-defined priority lists 116 allows the controller 102 to switch between the priority lists 116 such that different lists 116 are enforced (e.g., used) to determine the device connection priority at different times based on context. For example, the user may desire that a given electronic device connect to a first pairing electronic device (e.g., a headset) while the user is working, and may desire that the electronic device connect to a second pairing electronic device (e.g., an audio speaker) while the user is relaxing after work. The user's device connection preferences change with different situations, so providing the opportunity to create multiple different user-defined priority lists 116 tagged to multiple different situations allows for conforming to the user's varying situation-based preferences.

The one or more sensors 112 monitor corresponding parameters and generate (e.g., acquire) sensor measurements based on the corresponding parameters that are monitored. The sensors measurements are in the form of signals. The sensor measurements may be communicated to the controller 102 for the controller 102 to analyze the sensor measurements. The controller 102 may use the sensor measurements to determine which user-defined priority list 116 to select out of multiple different priority lists 116 in the set 118. For example, the sensor measurements may provide context and situational-awareness to the controller 102, which the controller 102 can use to determine which of the priority lists 116 is most applicable at a given time that a define connection request is received or generated. The one or more sensors may include an accelerometer, a GPS receiver, a position sensor, a speed sensor, or the like, as described in more detail herein.

FIG. 2 is a diagram of a network 200 of devices according to an embodiment. The network 200 includes a first electronic device 202 and a group 204 of pairing electronic devices 206. Each of the pairing electronic devices 206 may be able to participate in an independent bi-directional communication link with the first electronic device 202, at least when sufficiently proximate to the first electronic device 202 to be in-range. The device connection system 100 may be incorporated in the first electronic device 202, such that the first electronic device 202 is the host electronic device described above. As such, the controller 102 of the device connection system 100 may be disposed onboard the first electronic device 202. Optionally, one or more of the pairing electronic devices 206 in the group 204 may also, independently incorporate the device connection system 100 described herein.

The first electronic device 202 and the pairing electronic devices 206 in the group 204 may be any of the different types of electronic devices described herein. For example, the first electronic device 202 may be a source (e.g., leader) device that transmits data to a connected peripheral or end-use electronic device. The source device may include tablet computers, smartphones, laptop computers, and the like, that transmit data to an end-use device such as earbud headphones, headset headphones, audio speaker, computer mouse, and the like. The pairing electronic devices 206 may be different end-use electronic devices. In another example, the first electronic device 202 may be an end-use electronic device, such as headphones, and the pairing electronic devices 206 in the group 204 may be different source devices that control the first electronic device 202.

The first electronic device 202 is capable of establishing a respective wireless communication link with any of the pairing electronic devices 206, when sufficiently proximate to each other. In an example in which the device connection system 100 establishes Bluetooth communication links, the first electronic device 202 and the group 204 of pairing electronic devices 206 may form an ad hoc network 200 (e.g., a piconet) that links the devices 202, 206 using Bluetooth technology protocols. The first electronic device 202 can only be connected to one of the pairing electronic devices 206 at a time. For example, the first electronic device 202 may have to drop a connection with the first pairing electronic device (PED₁) 206 in order to establish a connection with the second pairing electronic device (PED₂) 206. Although four pairing electronic devices 206 are shown in FIG. 2, the first electronic device 202 may be paired with more or less than four electronic devices.

The controller 102 of the device connection system 100 determines the order at which the first electronic device 202 attempts to connect to the group 204 of pairing electronic devices 206 based on the user-defined priority list 116 (that is in force). In an example, the controller 102 within the first electronic device 202 may attempt, based on the user-defined priority list 116, to establish a wireless communication link with the third pairing electronic device (PED₃) 206 first. If the connection is unsuccessful, the controller 102 may then attempt to connect with the next-highest-priority device according to the priority list 116, which may be the fourth pairing electronic device (PED₄) 206, for example. The first successful connection attempt results in the first electronic device 202 establishing a wireless communication link with the corresponding pairing electronic device 206, which is referred to herein as a second electronic device 208. For example, if the first successful attempt is with the second pairing electronic device (PED₂) 206, then the second electronic device 208 is the second pairing electronic device 206 of the group 204.

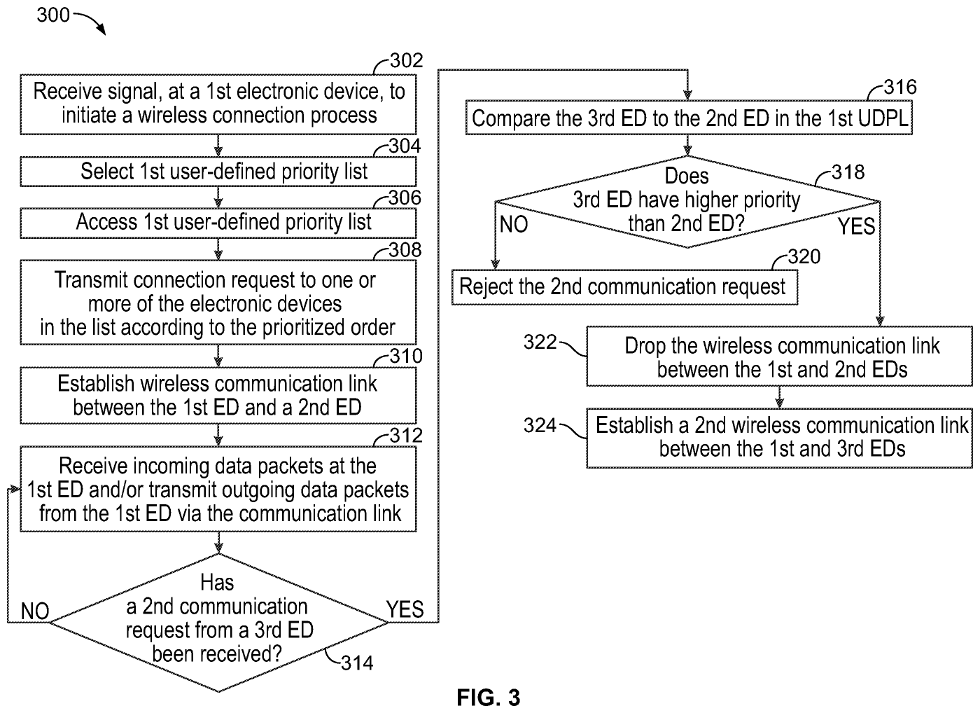

FIG. 3 is a flow chart 300 of a method of wirelessly connecting devices according to an embodiment. The method may be performed by the controller 102 of the device connection system 100 (e.g., the one or more processors 104 of the controller 102). The method is described with reference to the first electronic device 202 and the pairing electronic devices 206 shown in FIG. 2. For example, the device connection system 100 may be implemented by the first electronic device 202. The method optionally may include at least one additional step than shown, at least one fewer step than shown, and/or at least one different step than shown in FIG. 3.

At step 302, a signal to initiate a wireless connection process is received. The signal may be received by a user manipulating the input device 108. In an example, turning on or otherwise activating the first electronic device 202 may constitute the signal that automatically initiates the wireless connection process. The wireless connection process refers to the steps taken by the first electronic device 202 to establish a wireless communication link with another electronic device (referred to as a second electronic device 208). In another example, the signal to initiate the wireless connection process may be provided by the user activating the Bluetooth setting within the first electronic device 202.

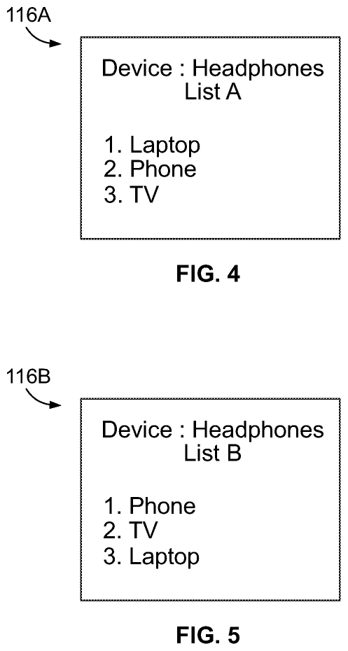

At step 304, a first user-defined priority list 116 is selected. The first user-defined priority list 116 includes a group 204 of pairing electronic devices 206 and a prioritized order of the pairing electronic devices 206 in the group 204. FIG. 4 illustrates the first user-defined priority list 116A according to an example embodiment. The list 116A is associated with headphones, such that the first electronic device 202 in this example, is a set of headphones. The pairing electronic devices 206 in the list 116A include a laptop, a phone (e.g., smartphone), and a television (TV). The laptop has the highest priority slot or rank, followed by the phone, and then the TV at the lowest priority slot or rank. In one embodiment, the first user-defined priority list 116A that is selected may be the only user-defined priority list 116 that is stored in the memory 114. In a second embodiment, the memory 114 may store a set 118 of multiple different user-defined priority lists 116. In this second embodiment, the selection at step 304 may represent selecting the first user-defined priority list 116A from the memory 114 over one or more other user-defined priority lists 116A stored in the memory 114. The controller 102 may determine which user-defined priority list 116 to select based on situational context. For example, the controller 102 may select the list 116 from the set 118 that is determined by the controller 102 to be the most applicable or appropriate to the current situation of the first electronic device 202 and/or the user that uses the first electronic device 202. This context-based selection process is described in more detail below after step 322.

At step 306, the first user-defined priority list 116A is accessed to determine the group of pairing electronic devices 206 and the prioritized order of the pairing electronic devices 206 in the group 204. For example, the controller 102 may access the first user-defined priority list 116A from the memory 114. At step 308, a connection request is transmitted to one or more of the pairing electronic devices 206 in the group 204, one at a time according to the prioritized order in the first user-defined priority list 116A. In the illustrated example shown in FIG. 4, the headphones representing the first electronic device 202 would first transmit a connection request to the laptop, which has the highest priority rank. The headphones would attempt to establish a wireless communication link with the laptop. The connection request may be transmitted by the wireless communication device 106. The connection attempt may be unsuccessful if the laptop is off or inactive, already connected to another device via a wireless bi-directional communication link, out of range of the headphones, or the like. If the connection with the laptop is not made within a designated amount of time, then the controller 102 determines that the connection attempt with the laptop is unsuccessful. In response, the controller 102 transmits a connection request to the next pairing electrode device 206 in the list 116. In the illustrated first list 116, the connection request is transmitted to the smart phone to attempt to connect the headphones to the smartphone. This sequence continues through the prioritized order of the list 116A until a successful connection is established.

At step 310, a wireless communication link is established between the first electronic device 202 and a second electronic device 208. The second electronic device 208 may be the pairing electronic devices 206 in the group 204 that is first to respond to the connection request. In an example, the second electronic device 208 may be the smartphone, which has the second priority rank in the first list 116A shown in FIG. 4. In an embodiment, the wireless communication link is a bi-directional communication link between the first electronic device 202 and the second electronic device 208 according to the Bluetooth protocol. At step 312, after establishing the wireless communication link, the method may include receiving, at the first electronic device 202 (e.g., the headphones), incoming data packets from the second electronic device 208 (e.g., the smartphone) via the wireless communication link. For example, the smartphone may transmit audio data to the headphones via the wireless communication link. In addition, or as an alternative, to receiving data from the second electronic device 208, the first electronic device 202 may transmit outgoing data packets to the second electronic device 208 via the wireless communication link.

At step 314, it is determined whether a second connection request has been received from a third electronic device after establishing the wireless communication link. The third electronic device sends the second connection request in an attempt to establish a wireless communication link with the first electronic device 202. The third electronic device may be one of the various types of electronic devices described herein. The third electronic device may send the second connection request upon activation of the third electronic device, upon coming in range of the first electronic device 202, or the like. The second connection request may be a message that is received by the wireless communication device 106. If the second connection request is not received, flow returns to step 312 to continue normal communications between the first and second electronic devices 202, 208. If the controller 102 indeed receives the second connection request, flow continues to step 316. At step 316, the third electronic device is compared to the second electronic device 208 according to the prioritized order in the user-defined priority list 116. For example, the second connection request may identify the third electronic device by providing an identifier, such as a unique part number. The controller 102 may determine the identity of the third electronic device, and then refer to the prioritized order of the user-defined priority list 116 that is in force at the time to compare the third electronic device to the second electronic device 208.

At step 318, it is determined whether the requesting device, i.e., the third electronic device, has a higher priority than the second electronic device 208 that is already connected to the first electronic device 202. If not, meaning that the second electronic device 208 has a higher priority in the priority list 116 in force than the third electronic device, the method proceeds to step 320. At step 320, the second connection request is rejected because the third electronic device has a lower priority than the currently-connected second electronic device 208. On the other hand, if the controller 102 determines that the third electronic device has a higher priority than the second electronic device 208 according to the priority list 116, then flow continues to step 322. For example, with reference to the first priority list 116A in FIG. 4, if the third electronic device is the TV, then the controller 102 would reject the second connection request because the smartphone, as the currently-connected device, has a higher priority than the TV. Alternatively, if the third electronic device is the laptop, the third electronic device has higher priority than the smartphone according to the applicable list 116A.

At step 322, upon determining that the third electronic device has higher priority than the second electronic device 208, the wireless communication link between the first electronic device 202 and the second electronic device 208 may be dropped. For example, the controller 102 may control the first electronic device 202 to break or disconnect the wireless communication link with the second electronic device 208. The controller 102 may control the wireless communication device 106 to transmit a notification message to the second electronic device 208 to inform the user of the second electronic device 208 about the connection change. At step 324, a second wireless communication link is established between the first electronic device 202 and the third electronic device. Thus, the controller 102 may automatically switch to an available electronic device that has a higher priority than the electronic device 208 that is currently connected to the first electronic device 202. Flow may then continue to a modified version of step 312, in which data packets are communicated between the first electronic device 202 and the third electronic device via the second wireless communication link.

Referring now back to step 304, the memory 114 may store a set 118 of multiple different user-defined priority lists 116 that are associated with different situations. For example, the first list 116A may be associated with the user's work and/or school activities. The user may mostly utilize the laptop computer while performing work and/or school tasks, so the laptop has the highest priority in the list 116A as shown in FIG. 4. The user may prefer that the headphones connect to the laptop while performing work and/or school tasks. FIG. 5 illustrates a second user-defined priority list 116B according to an example embodiment. This second list 116B may be in the same set 118 as the first list 116A, and is also associated with the headphones. In an example, the second list 116B may be associated with the user's recreation activities (e.g., non-work and non-school activities). When the user is not at work or school, the user may prefer that the headphones connect to the user's smartphone. Therefore, the smartphone is the highest priority device in the second user-defined priority list 116B. The smartphone is followed in order by the TV and then the laptop according to the second list 116B. The order of the pairing electronic devices changes between the two lists 116A, 116B because the user's preferences change based on the different situations in which the user is involved. For example, the user may typically not use the laptop after work or after school, so the headphones automatically attempting to connect to the laptop outside of work or school is undesirable.

In step 304, the controller 102 may select the first user-defined priority list 116A from the set 118 (e.g., instead of the other user-defined priority lists 116 in the set 118) based on context (e.g., situational awareness). The controller 102 may determine that the first user-defined priority list 116A is the most appropriate (e.g., applicable) list in the set 118 at the given time according to the current situation as interpreted by the controller 102. In one example, the controller 102 obtains context by referring to the internal clock device to determine the time of day at the time that the controller 102 is performing the wireless connection process described with reference to FIG. 3. In this example shown in FIGS. 4 and 5, the controller 102 may select the first list 116A, which is associated with work and/or school, during typical work and/or school hours. For example, the controller 102 may select that the first list 116A is in force Monday to Friday from 8 AM to 5 PM. During the weekend and weekday times outside of that 8 AM to 5 PM window, the controller 102 may select that the second list 116B is in force to determine the device priority. With reference to step 304, the controller 102 may determine that the current day and time is Tuesday at 10:30 AM, so the controller 102 selects the first priority list 116A.

In another example, the controller 102 may obtain context based on sensor measurements generating by the one or more sensors 112 that indicate activity of the user. For example, the controller 102 may analyze received one or more sensor measurements from the sensor(s) 112, and determine that the first priority list 116A is more applicable than other lists (e.g., the second list 116B) in the set 118 based on the one or more sensor measurements. In an example, the sensor measurements may be indicative of a location of the first electronic device 202. For example, the sensor 112 may be a location-determining sensor, such as a GPS receiver. The controller 102 may determine the location of the first electronic device 202 (e.g., the headphones) based on the sensor measurements. If the first electronic device 202 is at a location that corresponds to the user's place of work or school, then the controller 102 determines that the user is at work or school and selects the first priority list 116A. On the other hand, if the sensor measurements indicate that the first electronic device is at another location, such as at the user's home or is moving indicative of travel, then the controller 102 may select the second priority list 116B to enforce at that time. In an example, the location of the first electronic device 202 and the user can be determined based on identification of nearby networks and/or nearby devices to the first electronic device 202, instead of or in addition to relying on a sensor 112.

In another example, the sensor measurements may be indicative of an activity of the user that controls the first electronic device 202. For example, the sensor 112 may be an accelerometer, a speed sensor, a position sensor, or the like that monitor parameters such as acceleration, speed, and orientation of the first electronic device 202. The first electronic device 202 may be with the user, such that the activity of the first electronic device 202 may be imputed to the user. In an example, the accelerometer and/or speed sensor can be used to determine if the user is exercising (e.g., jogging) or traveling in a vehicle. If so, then the controller 102 may select a third user-based priority list 116 from the set 118 that is specific to at least one of these activities. For example, the user may create different priority lists 116 for various different situations, such as work/school, recreation/home, working out, driving, outdoor, indoor, and the like. Some situations may have multiple different sub-lists. For example, the user may create one work priority sub-list for working at the company office and a second work priority sub-list for working at the user's home office. The controller 102 optionally may collect information about the use of the device connection system 100, such as connection times and popularity of certain connections.

### CLOSING STATEMENTS

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

Aspects are described herein with reference to the Figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified. The program instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally, or alternatively, the units/modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Further, in the following claims, the phrases “at least A or B”, “A and/or B”, and “one or more of A and B” (where “A” and “B” represent claim elements), are used to encompass i) A, ii) B or iii) both A and B.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A method for establishing a device connection for wireless communications, the method comprising:
receiving, via one or more processors of a first electronic device, a signal to initiate a wireless connection process;
accessing a user-defined priority list to determine a group of pairing electronic devices and a prioritized order of the pairing electronic devices in the group;
transmitting a connection request to one or more of the pairing electronic devices in the group, one at a time according to the prioritized order in the user-defined priority list; and
establishing a wireless communication link between the first electronic device and a second electronic device, wherein the second electronic device is one of the pairing electronic devices in the group that is first to respond to the connection request.

2. The method of claim 1, further comprising one or more of (i) transmitting, by the first electronic device, outgoing data packets to the second electronic device via the wireless communication link, or (ii) receiving, at the first electronic device, incoming data packets from the second electronic device via the wireless communication link.

3. The method of claim 1, wherein, responsive to receiving a second connection request from a third electronic device after establishing the wireless communication link, the method comprises comparing the third electronic device to the second electronic device according to the prioritized order in the user-defined priority list.

4. The method of claim 3, further comprising rejecting the second connection request in response to determining that the second electronic device has a higher priority than the third electronic device.

5. The method of claim 3, wherein, responsive to determining that the third electronic device has a higher priority than the second electronic device, the method comprises:
dropping the wireless communication link between the first electronic device and the second electronic device, and
establishing a second wireless communication link between the first electronic device and the third electronic device.

6. The method of claim 1, wherein establishing the wireless communication link comprises establishing a bi-directional communication link between the first electronic device and the second electronic device according to the Bluetooth protocol.

7. The method of claim 1, wherein the user-defined priority list is a first user-defined priority list in a set of multiple different user-defined priority lists associated with different situations, and the method further comprises selecting the first user-defined priority list from the set.

8. The method of claim 7, further comprising receiving a sensor measurement generated by a sensor device, and wherein selecting the first user-defined priority list from the set comprises determining that the first user-defined priority list is more applicable than another user-defined priority list in the set based on the sensor measurement.

9. The method of claim 8, wherein the sensor measurement is indicative of one of a location of the first electronic device or an activity of a user that controls the first electronic device.

10. The method of claim 7, further comprising determining a time of day, and wherein selecting the first user-defined priority list from the set comprises determining that the first user-defined priority list is more applicable than another user-defined priority list in the set based on the time of day.

11. A device connection system comprising:
a memory configured to store program instructions;
a wireless communication device onboard a first electronic device; and
one or more processors communicatively connected to the memory and the wireless communication device, wherein the program instructions are executable by the one or more processors to:
receive a signal to initiate a wireless connection process;
access a user-defined priority list stored in the memory to determine a group of pairing electronic devices and a prioritized order of the pairing electronic devices in the group;
transmit, via the wireless communication device, a connection request to one or more of the pairing electronic devices in the group, one at a time according to the prioritized order in the user-defined priority list; and
establish a wireless communication link between the first electronic device and a second electronic device, wherein the second electronic device is one of the pairing electronic devices in the group that is first to respond to the connection request.

12. The device connection system of claim 11, wherein the program instructions are executable by the one or more processors to control the wireless communication device to one or more of (i) transmit outgoing data packets to the second electronic device via the wireless communication link or (ii) receive incoming data packets from the second electronic device via the wireless communication link.

13. The device connection system of claim 11, wherein, responsive to receiving a second connection request from a third electronic device after establishing the wireless communication link, the program instructions are executable by the one or more processors to compare the third electronic device to the second electronic device according to the prioritized order in the user-defined priority list.

14. The device connection system of claim 13, wherein the program instructions are executable by the one or more processors to reject the second connection request in response to the one or more processors determining that the second electronic device has a higher priority than the third electronic device in the user-defined priority list.

15. The device connection system of claim 13, wherein, responsive to the one or more processors determining that the third electronic device has a higher priority than the second electronic device in the user-defined priority list, the program instructions are executable by the one or more processors to:
drop the wireless communication link between the first electronic device and the second electronic device; and
establish a second wireless communication link between the first electronic device and the third electronic device.

16. The device connection system of claim 11, wherein the user-defined priority list is a first user-defined priority list in a set of multiple different user-defined priority lists associated with different situations, and the program instructions are executable by the one or more processors to select the first user-defined priority list from the set.

17. The device connection system of claim 16, wherein the program instructions are executable by the one or more processors to:
analyze a sensor measurement generated by a sensor device; and
select the first user-defined priority list from the set by determining that the first user-defined priority list is more applicable than another user-defined priority list in the set based on the sensor measurement.

18. The device connection system of claim 17, wherein the sensor measurement is indicative of one of a location of the first electronic device or an activity of a user that controls the first electronic device.

19. The device connection system of claim 16, wherein the program instructions are executable by the one or more processors to:
determine a time of day, and
select the first user-defined priority list from the set by determining that the first user-defined priority list is more applicable than another user-defined priority list in the set based on the time of day.

20. A computer program product comprising a non-transitory computer readable storage medium, the non-transitory computer readable storage medium comprising computer executable code configured to be executed by one or more processors to:
receive a signal to initiate a wireless connection process;
select a first user-defined priority list in a set of multiple different user-defined priority lists stored in the non-transitory computer readable storage medium and associated with different situations;
access the first user-defined priority list to determine a group of pairing electronic devices and a prioritized order of the pairing electronic devices in the group;
transmit, via a wireless communication device of a first electronic device, a connection request to one or more of the pairing electronic devices in the group, one at a time according to the prioritized order in the first user-defined priority list; and
establish a Bluetooth communication link between the first electronic device and a second electronic device, wherein the second electronic device is one of the pairing electronic devices in the group that is first to respond to the connection request.
